(19) United States
(12) Patent Application Publication
(10) Pub. No.: US 2009/0254729 A1
(43) Pub. Date: Oct. 8, 2009

(54) METHOD OF WEAR LEVELING FOR A NON-VOLATILE MEMORY

(75) Inventors: CHIEN CHENG LIN, HSINCHU (TW); HSIN JEN HUANG, HSINCHU (TW); SHIH CHIEH TAI, HSINCHU (TW); CHIH NAN YEN, HSINCHU (TW); FUJA SHONE, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: SKYMEDI CORPORATION, HSINCHU (TW)

(21) Appl. No.: 12/098,741

(22) Filed: Apr. 7, 2008

(51) Int. Cl. G06F 12/02

(52) U.S. Cl. 711/170; 711/E12.002

(57) ABSTRACT

According to the method of wear leveling for a non-volatile memory of the present invention, the non-volatile memory is divided into a plurality of windows, and a mapping table is built in which the logical block addresses having frequently accessed data are allocated equally to the plurality of windows. The logical block addresses may store a File Allocation Table (FAT) or a directory table; therefore the windows they locate will be written or erased more frequently. In an embodiment, the logical block addresses having frequently accessed data are allocated on a one-to-one basis to the plurality of windows. For example, the plurality of windows may comprise Windows 0, 1, 2 and 3, the logical block addresses comprise logical block addresses 0, 1, 2 and 3, and logical block addresses 0, 1, 2 and 3 point to Windows 0, 1, 2 and 3, respectively.

### BACKGROUND OF THE INVENTION

(A) Field of the Invention

The present invention is related to a method of wear leveling for a non-volatile memory.

(B) Description of Related Art

In consideration of limitations to RAM size, a wear leveling technology usually divides a non-volatile memory into a plurality of windows (zones) for write and/or erase functions. For wear leveling to blocks on a window basis, the blocks within a window are worn equally, but normally the wearing in different windows is not equalized.

FIG. 1A and FIG. 1B show an example of the wear for a non-volatile memory, e.g., a flash memory. Referring to FIG. 1A, a non-volatile memory is divided into four windows, and each window comprises 1,024 physical blocks. That is, Window 0 comprises physical blocks 0 to 1023, Window 1 comprises physical blocks 1024 to 2047, Window 2 comprises physical blocks 2048 to 3071, and Window 3 comprises physical blocks 3072 to 4095. According to the mapping table, logical block addresses 0 to 4095 point to the physical block addresses 0 to 4095, respectively.

Usually, the initial blocks of the first window (Window 0) store some system information such as the file table or directory table. For example, Block 0 of Window 0 may store the File Allocation Table (FAT), which is updated whenever data is written to any window. Because Block 0 of Window 0 usually stores the FAT, the erase function (wear) occurs more often in Window 0 than in other windows. Therefore, although Window 0 also undergoes wear leveling, the high wear counts caused by the frequent use of the FAT increases the average wear counts in Window 0 more quickly than in the other windows.

Consequently, the blocks in Window 0 have higher erase counts than those of other windows, as shown in FIG. 1B. For Window 0, for example, physical block address (PBA) 0 to PBA 1023, the erase count is approximately 6,000 to 7,000. For Window 1, i.e., PBA 1024 to PBA 2047, the erase count is around 3,300 to 3,500. For Window 2, i.e., PBA 2048 to PBA 3071, the erase count is around 3,000 to 3,400. For Window 3, i.e., PBA 3072 to PBA 4095, the erase count is around 3,600 to 3,800.

Therefore, it is useful to decrease the wear count in the first window (Window 0), so as to equalize the wear in all windows. As such, the endurance of the non-volatile memory will be increased.

### SUMMARY OF THE INVENTION

The present invention provides a method of wear leveling for a non-volatile memory, by which the blocks of a window having higher wear counts will be allocated to other blocks in other windows, so that the wear in all windows can be substantially equalized and the endurance of the non-volatile memory will be increased.

According to the method of wear leveling for a non-volatile memory of the present invention, the non-volatile memory is divided into a plurality of windows, and a mapping table of the non-volatile memory allocates the logical block addresses having frequently accessed data to the plurality of windows equally. In an embodiment, the logical block addresses may store a file allocation table (FAT) or a directory table, therefore the windows they locate will be written or erased more frequently.

In an embodiment related to four windows, the plurality of windows comprise Windows 0, 1, 2 and 3, the logical block addresses comprise logical block addresses 0, 1, 2 and 3, and logical block addresses 0, 1, 2 and 3 point to Windows 0, 1, 2 and 3, respectively.

In accordance with the present invention, because the logical block addresses having frequently accessed data are allocated to the plurality of windows equally, the wear count will not be concentrated on a single window. Consequently, the endurance or lifetime of the non-volatile memory can be significantly increased.

### BRIEF DESCRIPTION OF THE DRAWINGS

FIG. 1A illustrates the mapping between logical block addresses and physical block addresses according to a prior art;

FIG. 1B illustrates the relation between physical block addresses and erase counts of a prior art;

FIG. 2A illustrates the mapping between logical block addresses and physical block addresses according to an embodiment of the present invention;

FIG. 2B illustrates the relation between physical block addresses and erase counts in accordance with an embodiment of the present invention; and

FIG. 3 to FIG. 5 illustrate other embodiments of the method of wear leveling for a non-volatile memory of the present invention.

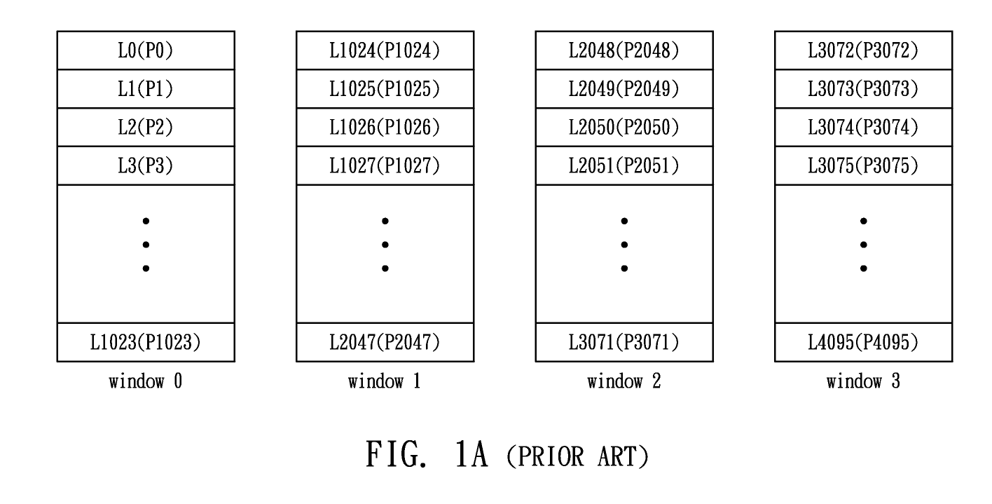

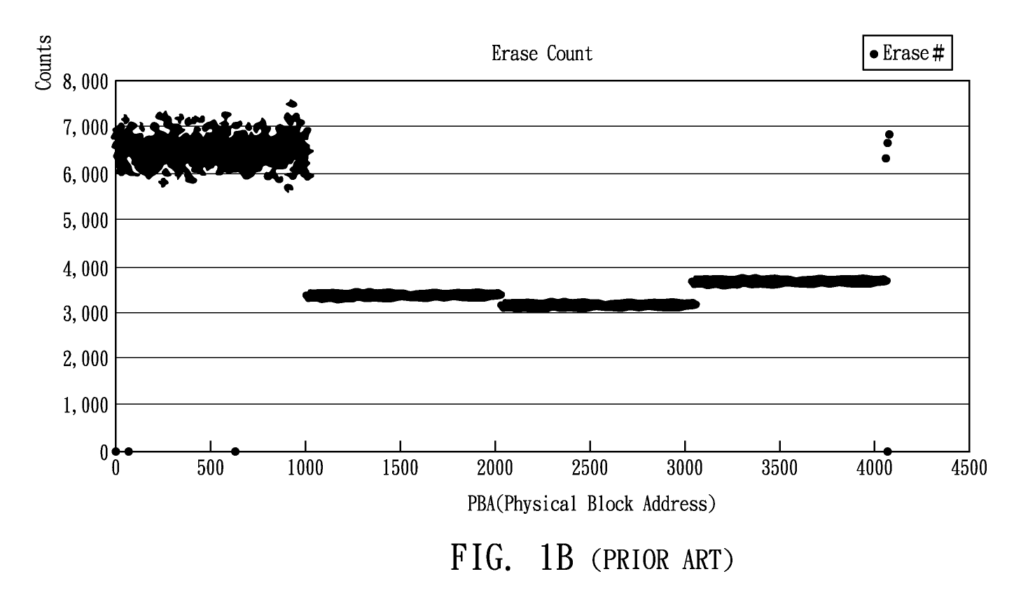

### DETAILED DESCRIPTION OF THE INVENTION

Embodiments of the present invention will now be described with reference to the accompanying drawings.

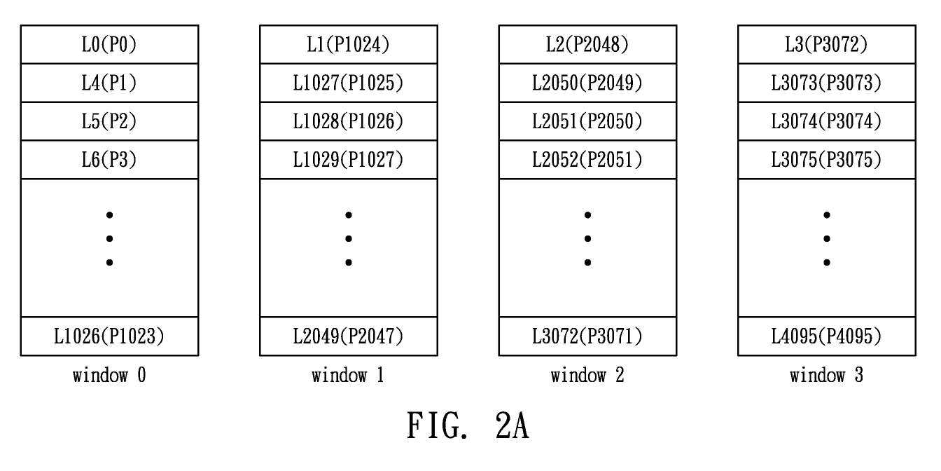

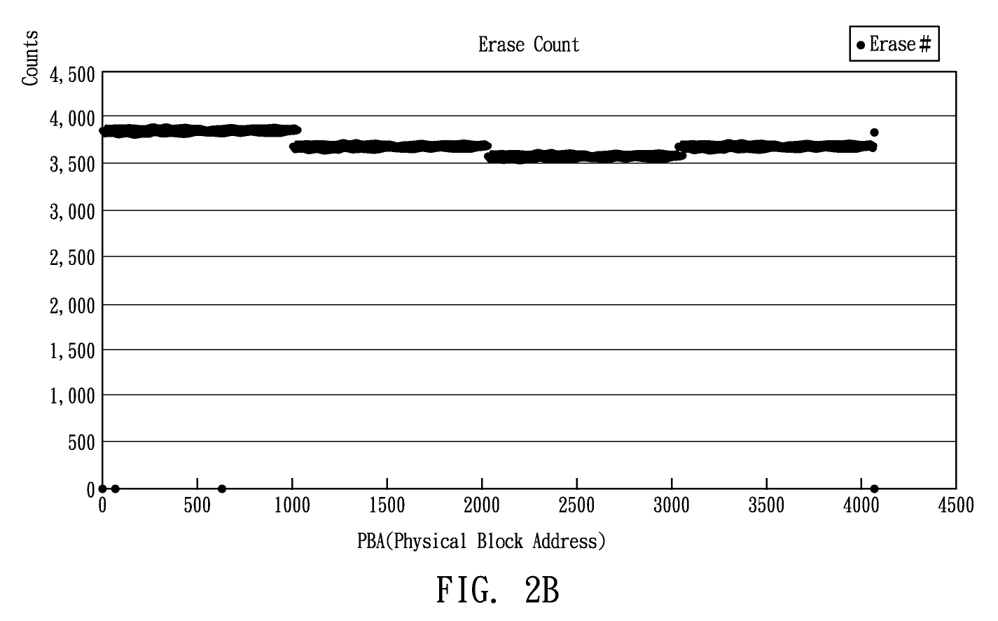

Referring to FIG. 2A and FIG. 2B, a non-volatile memory such as a flash memory is divided into four windows including Window 0, Window 1, Window 2 and Window 3. Each window includes 1,024 physical blocks, and thus there are in total 4,096 blocks in the non-volatile memory. Window 0 comprises the physical blocks P0 to P1023, Window 1 comprises the physical blocks P1024 to P2047, Window 2 comprises the physical blocks P2048 to P3071, and Window 3 comprises the physical blocks P3072 to P4095.

Assuming the physical block addresses pointed to by the logical block addresses L0, L1, L2 and L3 store system information such as the File Allocation Table (FAT) and/or directory table, the data is frequently accessed in the physical blocks directed by L0, L1, L2 and L3. In order to avoid the wear concentrating on Window 0, L1 is allocated to point to P1024, i.e., the first block of Window 1, L2 is allocated to point to P2048, and L3 is allocated to point to P3072. Then, other logical block addresses point to Window 0 first. When Window 0 is used completely, logical block addresses are allocated to Window 1. Likewise, the remaining logical block addresses are allocated to Window 2 and Window 3 when Window 1 and Window 2 are used completely. Accordingly, logical block addresses L4 to L1026 point to Window 0, logical block addresses L1027 to L2049 point to Window 1, logical block addresses L2050 to L3072 point to Window 2, and logical block addresses L3073 to L4095 point to Window 3. As a result, the erase count would be equalized among different windows as shown in FIG. 2B in which the erase count in each of the windows is between around 3,500 and 4,000.

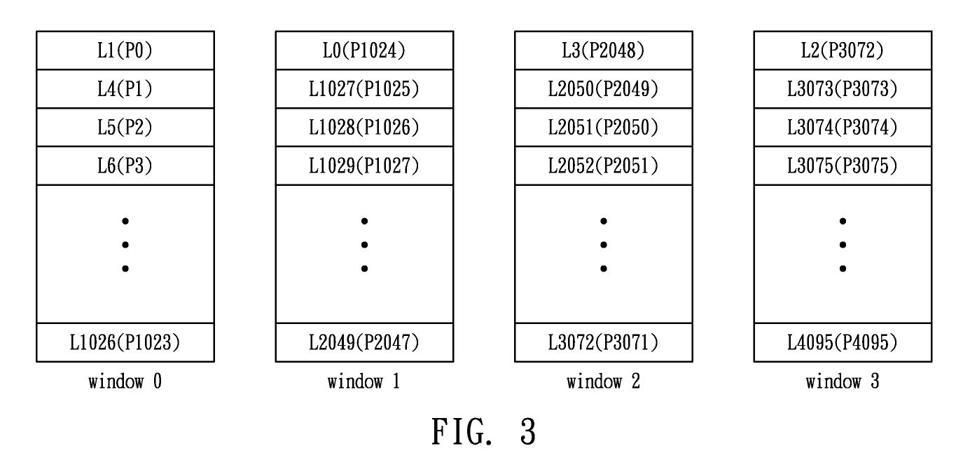

In practice, L0, L1, L2 and L3 are not limited to be directed to Window 0, Window 1, Window 2 and Window 3, respectively. As long as the four logical block addresses can be directed on a one-to-one basis to the four windows, e.g., logical block addresses L0, L1, L2 and L3 can be directed to Window 1, Window 0, Window 3 and Window 2 as shown in FIG. 3, the non-uniform wear count problem will be solved.

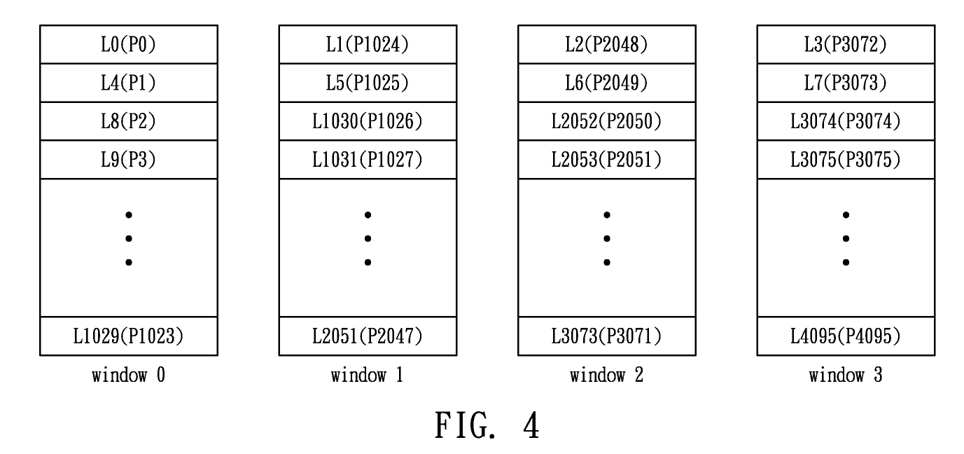

In FIG. 4, the logical block addresses L0 to L3 are directed to Window 0 to Window 3 in sequence, and the logical block addresses L4 to L7 are directed to Window 0 to Window 3 also, if the frequently accessed data are located in L0 to L7. As a result, the wear for the four windows can be equalized.

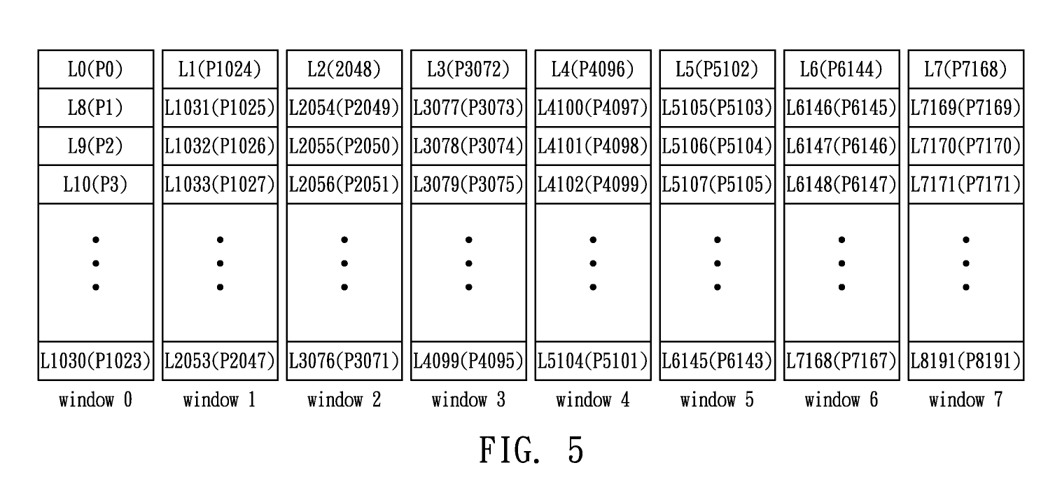

A non-volatile memory of a large size may be divided into 8 windows as shown in FIG. 5. Assuming frequently accessed data is located in the logical block addresses L0 to L7, L0 to L7 are allocated to physical blocks P0 in Window 0, P1024 in Window 1, P2048 in Window 2, P3072 in Window 3, P4096 in Window 4, P5120 in Window 5, P6144 in Window 6 and P7168 in Window 7, respectively.

In summary, the present invention provides an efficient way to disperse the frequently accessed data to be equally allocated to different windows, thereby equalizing the wear count across windows and improving the endurance and lifetime of the non-volatile memory.

The above-described embodiments of the present invention are intended to be illustrative only. Numerous alternative embodiments may be devised by those skilled in the art without departing from the scope of the following claims.

What is claimed is:

1. A method of wear leveling for a non-volatile memory, comprising the steps of:
dividing the non-volatile memory into a plurality of windows; and
allocating logical block addresses having frequently accessed data to the plurality of windows equally.

2. The method of claim 1, wherein the logical block addresses store the File Allocation Table (FAT).

3. The method of claim 1, wherein the logical block addresses store the directory table.

4. The method of claim 1, wherein the logical block addresses having frequently accessed data point to the plurality of windows on a one-to-one basis.

5. The method of claim 1, wherein the plurality windows comprise four windows, the logical block addresses comprise four logical block addresses, and the four logical block addresses point on a one-to-one basis to the four windows.

6. The method of claim 1, wherein the plurality of windows comprise Windows 0, 1, 2 and 3, the logical block addresses comprise logical block addresses 0, 1, 2 and 3, and logical block addresses 0, 1, 2 and 3 point to Windows 0, 1, 2 and 3, respectively.

7. A method of wear leveling for a non-volatile memory, comprising the steps of:
dividing the non-volatile memory into a plurality of windows; and
building a mapping table allocating logical block addresses having frequently accessed data to the plurality of windows equally.

8. The method of claim 7, wherein the logical block addresses store the File Allocation Table (FAT).

9. The method of claim 7, wherein the logical block addresses store the directory table.

10. The method of claim 7, wherein the logical block addresses having frequently accessed data point on a one-to-one basis to the plurality of windows.

11. The method of claim 7, wherein the plurality of windows comprise four windows, the logical block addresses comprise four logical block addresses, and the four logical block addresses point on a one-to-one basis to the four windows.

12. The method of claim 7, wherein the plurality of windows comprise Windows 0, 1, 2 and 3, the logical block addresses comprise logical block addresses 0, 1, 2 and 3, and logical block addresses 0, 1, 2, 3 points to Windows 0, 1, 2 and 3, respectively.
